(19) United States
(12) Patent Application Publication
(10) Pub. No.: US 2010/0052523 A1
(43) Pub. Date: Mar. 4, 2010

(54) ORGANIC LIGHT EMITTING DEVICE AND ORGANIC LIGHT EMITTING DISPLAY APPARATUS

(75) Inventors: Won-Jong KIM, Suwon-si (KR); Chang-Ho Lee, Suwon-si (KR); Jong-Hyuk Lee, Suwon-si (KR); Young-Woo Song, Suwon-si (KR); Yong-Tak Kim, Suwon-si (KR); Joon-Gu Lee, Suwon-si (KR); Jin-Baek Choi, Suwon-si (KR); Kyu-Hwan Hwang, Suwon-si (KR); Hee-Joo Ko, Suwon-si (KR); Il-Soo Oh, Suwon-si (KR); Se-Jin Cho, Suwon-si (KR); Hye-Lim Lee, Suwon-si (KR)

Correspondence Address: STEIN MCEWEN, LLP, 1400 EYE STREET, NW, SUITE 300, WASHINGTON, DC, 20005, US

(73) Assignee: Samsung Mobile Display Co., Ltd., Yongin-city (KR)

(21) Appl. No.: 12/542,044

(22) Filed: Aug. 17, 2009

(30) Foreign Application Priority Data
Aug. 29, 2008 (KR) 2008-85535

(51) Int. Cl. H01J 1/63

(52) U.S. Cl. 313/504

(57) ABSTRACT

An organic light emitting diode (OLED) including a first electrode formed on a substrate; an intermediate layer formed on the first electrode and including an organic emission layer; and a second electrode formed on the intermediate layer, wherein at least one from among the first electrode and the second electrode is formed as a transparent electrode including a material selected from the group consisting of MoOₓ, WOx, YbOₓ, ReOₓ, GeOₓ, and combinations thereof. In this manner, the performance of the transparent electrode is enhanced.

### CROSS-REFERENCE TO RELATED APPLICATIONS

This application claims the benefit of Korean Patent Application No. 2008-85535, filed on Aug. 29, 2008, in the Korean Intellectual Property Office, the disclosure of which is incorporated herein by reference.

### BACKGROUND OF THE INVENTION

1. Field of the Invention

Aspects of the present invention relate to an organic light emitting device (OLED) and an organic light emitting display apparatus, and more particularly, to an OLED and an organic light emitting display apparatus including the OLED that has a transparent electrode with an enhanced performance.

2. Description of the Related Art

Recently, display devices have been replaced with portable, thin, and flat display devices. One of these flat display devices is an electroluminescent display device, which is an active matrix type display device that is expected to become a next generation display device due to its wide viewing angle, high contrast, and high response speed. Also, compared to an inorganic light emitting display device, an organic light emitting display device having an emissive layer formed of an organic material is advantageous due to its superior features in terms of luminance, driving voltage, and response speed, and its capability to realize multi-colors.

An organic light emitting display apparatus includes an organic light emitting device (OLED). The OLED includes an anode electrode, a cathode electrode, and an intermediate layer disposed between the anode electrode and the cathode electrode. The intermediate layer includes an organic emission layer and other organic materials. When a voltage is applied to the anode electrode and the cathode electrode, the organic emission layer emits light.

At this time, the anode electrode and the cathode electrode may be formed of materials capable of transmitting the light. In particular, the anode electrode is commonly formed of indium tin oxide (ITO) having a high work function so that hole injection may be easily performed.

However, ITO has a slow etch rate in a wet etching process, and thus, it is difficult to perform patterning with respect to ITO. Also, since ITO has a high absorption coefficient k, which is an optical constant, if ITO is formed to be an electrode having a thickness greater than a predetermined thickness, the amount of light absorbed by the electrode increases. In this case, the light emitted from the organic emission layer does not pass through the electrode, resulting in degradation of luminance and luminous efficiency of the OLED. Accordingly, it is difficult to increase a thickness of an electrode, which is formed of ITO, beyond a predetermined thickness, and many restrictions occur in other processes.

### SUMMARY OF THE INVENTION

Aspects of the present invention provide an organic light emitting diode (OLED) and an organic light emitting display apparatus including the OLED that has a transparent electrode having an enhanced performance.

According to an aspect of the present invention, there is provided an OLED including a first electrode formed on a substrate; an intermediate layer formed on the first electrode and including an organic emission layer; and a second electrode formed on the intermediate layer, wherein at least one of the first electrode and the second electrode is formed as a transparent electrode comprising a material selected from the group consisting of MoOₓ, WOx, YbOₓ, ReOₓ, GeOₓ, and combinations thereof.

According to another aspect of the present invention, there is provided an organic light emitting display apparatus including a substrate; a thin film transistor (TFT) formed on the substrate; a passivation layer covering the TFT and including a contact hole; a first electrode formed on the passivation layer and electrically connected to the TFT via the contact hole; an organic emission layer formed on the first electrode; and a second electrode formed on the organic emission layer, wherein at least one of the first electrode and the second electrode is formed as a transparent electrode comprising a material selected from the group consisting of MoOₓ, WOx, YbOₓ, ReOₓ, GeOₓ, and combinations thereof.

According to an aspect of the present invention, a thickness of the transparent electrode may be between about 20 Å and 1000 Å.

According to an aspect of the present invention, light generated in the organic emission layer may be transmitted through the second electrode, and the first electrode may include a first layer formed as a reflective layer on the substrate so as to reflect the light generated in the organic emission layer; and a second layer disposed between the first layer and the intermediate layer and including a material selected from the group consisting of MoOₓ, WOx, YbOₓ, ReOₓ, GeOₓ, and combinations thereof.

According to an aspect of the present invention, the transparent electrode may be an anode electrode.

According to an aspect of the present invention, the light generated in the organic emission layer may resonate within the organic emission layer and the first electrode.

According to an aspect of the present invention, light generated in the organic emission layer may be transmitted through the second electrode, and the first electrode may include a first layer formed as a reflective layer on the passivation layer so as to reflect the light generated in the organic emission layer; and a second layer disposed between the first layer and the organic emission layer and including a material selected from the group consisting of MoOₓ, WOx, YbOₓ, ReOₓ, GeOₓ, and combinations thereof.

According to an aspect of the present invention, light generated in the organic emission layer may be transmitted through the substrate, and the second electrode may include a first layer formed on the organic emission layer and including a material selected from the group consisting of MoOₓ, WOx, YbOₓ, ReOₓ, GeOₓ, and combinations thereof; and a second layer formed as a reflective layer on the first layer so as to reflect the light generated in the organic emission layer.

According to an aspect of the present invention, the first electrode may include a first layer formed on the passivation layer and including a material selected from the group consisting of MoOₓ, WOx, YbOₓ, ReOₓ, GeOₓ, and combinations thereof; a second layer formed as a reflective layer on the first layer facing toward the organic emission layer so as to reflect the light generated in the organic emission layer; and a third layer disposed between the second layer and the organic emission layer and including a material selected from the group consisting of MoOₓ, WOx, YbOₓ, ReOₓ, GeOₓ, and combinations thereof.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of an organic light emitting diode (OLED) according to an embodiment of the present invention;

FIGS. 2 through 4 are graphs showing a current density versus a voltage with respect to the OLED of FIG. 1;

FIG. 5 is a magnified cross-sectional view of A of FIG. 1;

FIG. 6 is a cross-sectional view of an OLED according to another embodiment of the present invention;

FIG. 7 is a magnified view of B of FIG. 6;

FIG. 8 is a cross-sectional view of an OLED according to another embodiment of the present invention;

FIG. 9 is a cross-sectional view of an OLED according to another embodiment of the present invention;

FIG. 10 is a magnified view of C of FIG. 9;

FIG. 11 is a cross-sectional view of an organic light emitting display apparatus according to an embodiment of the present invention;

FIG. 12 is a cross-sectional view of an organic light emitting display apparatus according to another embodiment of the present invention;

FIG. 13 is a magnified view of D of FIG. 12;

FIG. 14 is a cross-sectional view of an organic light emitting display apparatus according to another embodiment of the present invention;

FIG. 15 is a magnified view of E of FIG. 14;

FIG. 16 is a cross-sectional view of an organic light emitting display apparatus according to another embodiment of the present invention;

FIG. 17 is a cross-sectional view of an organic light emitting display apparatus according to another embodiment of the present invention; and

FIG. 18 is a magnified view of F of FIG. 17.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

It will be understood that when an element, such as a layer, film, region, or substrate is referred to as being formed or disposed on another element, it can be directly on the other element, or intervening elements may also be present. In contrast, when an element is referred to as being formed or disposed directly on another element, there are no intervening elements present.

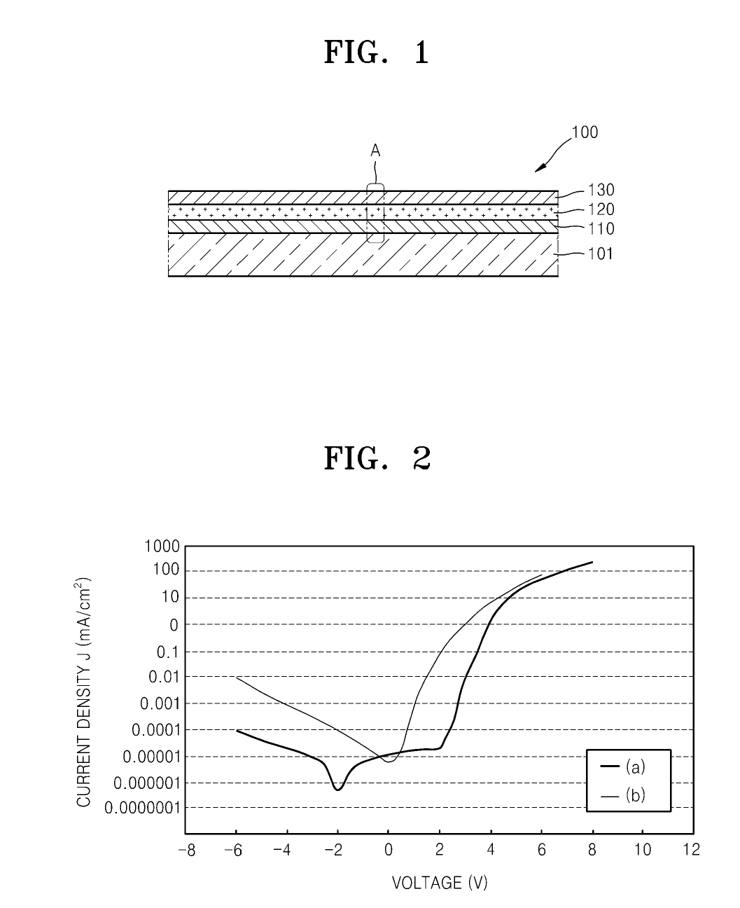

FIG. 1 is a cross-sectional view of an organic light emitting diode (OLED) 100 according to an embodiment of the present invention. Referring to FIG. 1, the OLED 100 includes a substrate 101, a first electrode 110, an intermediate layer 120, and a second electrode 130.

The substrate 101 may be formed of transparent glass containing SiO₂ as a main component, but is not limited thereto, and thus may also be formed of a transparent plastic material that may be an insulating organic material selected from the group consisting of polyethersulphone (PES), polyacrylate (PAR), polyetherimide (PEI), polyethyelene napthalate (PEN), polyethyelene terephthalate (PET), polyphenylene sulfide (PPS), polyallylate, polyimide, polycarbonate (PC), triacetate cellulose (TAC), and cellulose acetate propionate (CAP).

If an organic light emitting display apparatus including the OLED 100 is a bottom emission type organic light emitting display apparatus in which an image is realized toward the substrate 101, the substrate 101 is formed of a transparent material. However, if the organic light emitting display apparatus including the OLED 100 is a top emission type organic light emitting display apparatus in which an image is realized away from the substrate 101, the substrate 101 need not be formed of a transparent material, and, in this case, the substrate 101 may be formed of a metal. When the substrate 101 is formed of a metal, the substrate 101 may include at least one material selected from the group consisting of carbon, iron, chromium, manganese, nickel, titanium, molybdenum, stainless steel (SUS), Invar alloys, Inconel alloys, and Kovar alloys, but is not limited thereto, and thus, the substrate 101 may also be formed of a metal foil.

The first electrode 110 is formed on the substrate 101. The first electrode 110 may be formed according to a predetermined pattern by using a photolithography method or the like. The first electrode 110 is formed to be a transparent electrode so as to transmit light therethrough. The first electrode 110 includes materials selected from the group consisting of MoOₓ, WOx, YbOₓ, ReOₓ, GeOₓ, and combinations thereof. Such materials have a large dipole moment and are appropriate for an electrode material.

Typically, a transparent electrode of an OLED is formed of a material, such as indium tin oxide (ITO). However, ITO has a high optical absorption coefficient k and thus, ITO may not sufficiently transmit light. Due to such an ITO characteristic, it is difficult to increase a thickness of a transparent electrode formed of ITO beyond a predetermined value. Also, ITO has a slow etch rate in a wet etching process, such that it is difficult to perform patterning with respect to ITO.

When the first electrode 110 includes the material selected from the group consisting of MoOₓ, WOx, YbOₓ, ReOₓ, GeOₓ, and combinations thereof, the selected material has a low optical absorption coefficient k such that the amount of light passing through the first electrode 110 increases, compared to ITO. Thus, even if the first electrode 110 is formed to a predetermined thickness, transmittance is not significantly reduced.

Also, the material selected from the group consisting of MoOₓ, WOₓ, YbOₓ, ReOₓ, GeOₓ, and combinations thereof has a faster etch rate than ITO so that it is easy to perform patterning with respect to the first electrode 110.

The material selected from the group consisting of MoOₓ, WOₓ, YbOₓ, ReOₓ, GeOₓ, and combinations thereof is a material that has a large dipole moment and is appropriate for an electrode material. In particular, when the first electrode 110 is formed of the material having a work function that is adjusted between 5 eV through 6.5 eV, the first electrode 110 may be an anode electrode that has enhanced hole injection performance.

The intermediate layer 120 and the second electrode 130 are formed on the first electrode 110. The intermediate layer 120 includes an organic emission layer formed of either a low molecular weight organic material or a polymer organic material. For example, an organic material forming the organic emission layer may include oxadiazole dimer dyes (Bis-DAPOXP)), spiro compounds (Spiro-DPVBi, Spiro-6P), triarylamine compounds, bis(styryl)amine(DPVBi, DSA), 4,4′-bis(9-ethyl-3-carbazovinylene)-1,1′-biphenyl (BCzVBi), perylene, 2,5,8,11-tetra-tert-butylperylene (TPBe), 9H-carbazol-3,3′-(1,4-perylene-di-2,1-ethen-diyl)bis[9-ethyl-(9C)] (BCzVB), 4,4-bis[4-(di-p-tolylamino)styryl]biphenyl (DPAVBi), 4-(di-p-tolylamino)-4′-[(di-p-tolylamino)styryl]stilbene (DPAVB), 4,4′-bis[4-(diphenylamino)styryl]biphenyl (BDAVBi), bis(3,5-difluoro-2-(2-pyridyl)phenyl-(2-carboxypyridyl)Iridium III (FIrPic), etc., for blue color emission; 3-(2-benzothiazolyl)-7-(diethylamino)Coumarin 6 2,3,6,7-tetrahydro-1,1,7,7,-tetramethyl-1H,5H,11H-10-(2-benzothiazolyl)quinolizino-[9,9a,1gh] Coumarin (C545T), N,N′-dimethy-quinacridone (DMQA), tris(2-phenylpyridine) Iridium (III) (Ir(ppy)3), etc., for green color emission; and Tetraphenylnaphthacene (Rubrene), tris(1-phenylisoquinoline) Iridium (III), bis(2-benzo[b]thiophene-2-yl-pyridine) acetylacetonate Iridium (III) (Ir(btp)2(acac)), tris(dibenzoylmethan)phenanthoroline europium (III) (Eu(dbm)3(phen)), tris[4,4′-di-tert-butyl-(2,2′)-bipyridine]ruthenium (III)complex(Ru(dtb-bpy)3*2(PF6)), DCM1, DCM2, Eu(thenoyltrifluoroacetone)3 (Eu(TTA)3, butyl-6-(1,1,7,7-tetramethyljulolidyl-9-enyl)-4H-pyran: DCJTB), etc., for red color emission.

Also, the organic emission layer arranged in the intermediate layer 120 may include an aromatic compound containing a polymer organic material, such as a phenylene-based polymer organic material, a phenylene vinylene-based polymer organic material, a thiophene-based polymer organic material, a fluorine-based polymer organic material, and a spiro-fluorene-based polymer organic material, and nitrogen, but is not limited thereto.

Also, the organic emission layer may be formed by adding dopants to a host. A luminescent host forming the organic emission layer may include tris(8-hydroxy-quinolinato)aluminum (Alq3), 9,10-di(nafti-2-yl)anthracene (AND), 3-Tert-butyl-9,10-di(nafti-2-yl)anthracene (TBADN), 4,4′-bis(2,2-dipheny-ethene-1-yl)-4,4′-dimethylphenyl (DPVBi), 4,4′-Bis(2,2-diphenyl-ethene-1-yl)-4,4′-dimethylphenyl (p-DMDPVBi), Tert(9,9-diarylfluorene)s (TDAF), 2-(9,9′-spirobifluorene-2-yl)-9,9′-spirobifluorene (BSDF), 2,7-bis(9,9′-spirobifluorene-2-yl)-9,9′-spirobifluorene (TSDF), bis(9,9-diarylfluorene)s (BDAF), 4,4′-bis(2,2-diphenyl-ethene-1-yl)-4,4′-di-(tert-butyl)phenyl (p-TDPVBi), etc. A phosphorescent host forming the organic emission layer may include 1,3-bis(carbazole-9-yl)benzene (mCP), 1,3,5-tris(carbazole-9-yl)benzene (tCP), 4,4′,4″-tris(carbazole-9-yl)triphenylamine (TcTa), 4,4′-bis(carbazole-9-yl)biphenyl (CBP), 4,4′-bis(9-carbazolyl)-2,2′-dimethyl-biphenyl (CBDP), 4,4′-bis(carbazole-9-yl)-9,9-dimethyl-fluorene (DMFL-CBP), 4,4′-bis(carbazole-9-yl)-9,9-bis(9-phenyl-9H-carbazole)fluorene (FL-4CBP), 4,4′-bis(carbazole-9-yl)-9,9-di-tolyl-fluorene (DPFL-CBP), 9,9-bis(9-phenyl-9H-carbazole)fluorene (FL-2CBP), etc. At this time, dopant content may vary according to a material forming the organic emission layer.

Also, a hole transport layer and a hole injection layer may be stacked on the organic emission layer of the intermediate layer 120 closer to the first electrode 110, and an electron transport layer and an electron injection layer may be stacked on the organic emission layer of the intermediate layer 120 closer to the second electrode 130.

The second electrode 130 may be formed to be a transparent electrode or a reflective electrode. When formed to be the transparent electrode, the second electrode 130 may include a layer in which Li, Ca, LiF/Ca, LiF/Al, Al, Mg, or a compound of any of these is deposited toward the intermediate layer 120, and may also include thereon a layer formed of a transparent conductive material, such as indium tin oxide (ITO), indium zinc oxide (IZO), ZnO, or In₂O₃, or combinations thereof. The second electrode 130 may be formed of a transparent conductive material, such as ITO, IZO, ZnO, In₂O₃, or combinations thereof. Further, when formed to be the transparent electrode, the second electrode 130 may be formed of a material selected from the group consisting of MoOₓ, WOₓ, YbOₓ, ReOₓ, GeOₓ, and combinations thereof. When formed to be the reflective electrode, the second electrode 130 may be formed by depositing Li, Ca, LiF/Ca, LiF/Al, Al, Mg or a compound of any of these. The second electrode 130 may be a cathode electrode.

When a voltage is applied to the organic emission layer of the intermediate layer 120 that is disposed between the first electrode 110 and the second electrode 130, the organic emission layer emits light.

FIGS. 2 through 4 are graphs showing that an electrical performance of the OLED 100 is not reduced even though the first electrode 110 according to the embodiment of FIG. 1 includes a material selected from the group consisting of MoOₓ, WOx, YbOₓ, ReOₓ, GeOₓ, and combinations thereof.

FIG. 2 shows curves of a current density J versus a voltage V with respect to the OLED 100 of FIG. 1 and a conventional OLED according to the related art. To be more specific, (a) of FIG. 2 indicates a curve obtained by measuring a current density of the conventional OLED that uses ITO as a first electrode, and (b) of FIG. 2 indicates a curve obtained by measuring a current density of the OLED 100 that has the first electrode 110 including YbOₓ.

Referring to the curve (b) of FIG. 2, it is apparent that the OLED 100 of the curve (b) has a switching effect and a driving voltage performance which are superior to those of the conventional OLED of the curve (a). At this time, the x of YbOₓ may have a value between 1.4 through 1.6, but is not limited thereto.

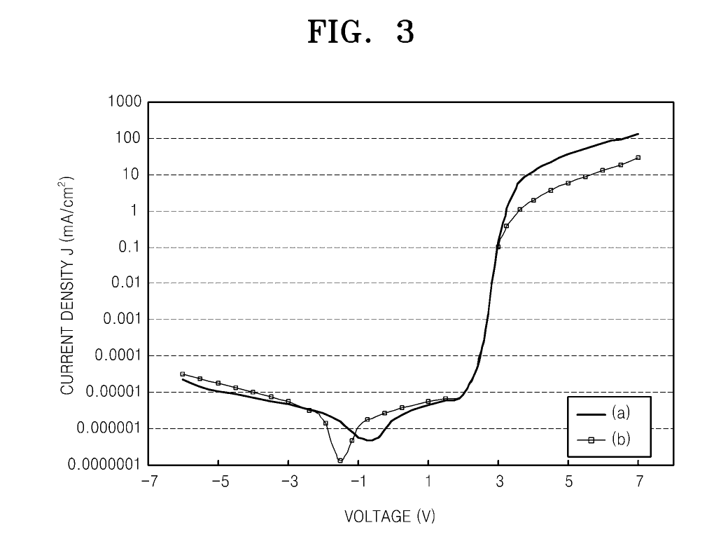

FIG. 3 shows curves of a current density J versus a voltage V with respect to the OLED 100 of FIG. 1 and a conventional OLED according to the related art. To be more specific, (a) of FIG. 3 indicates a curve obtained by measuring a current density of the OLED 100 that has the first electrode 110 including MoOₓ and (b) of FIG. 3 indicates a curve obtained by measuring a current density of the conventional OLED that has a first electrode having ITO. Referring to FIG. 3, it is apparent that the electrical performance of the OLED 100 is substantially the same as that of the conventional OLED even though the first electrode 110 is formed of MoOₓ. The x of MoOₓ may have a value between 1.5 through 3, but is not limited thereto.

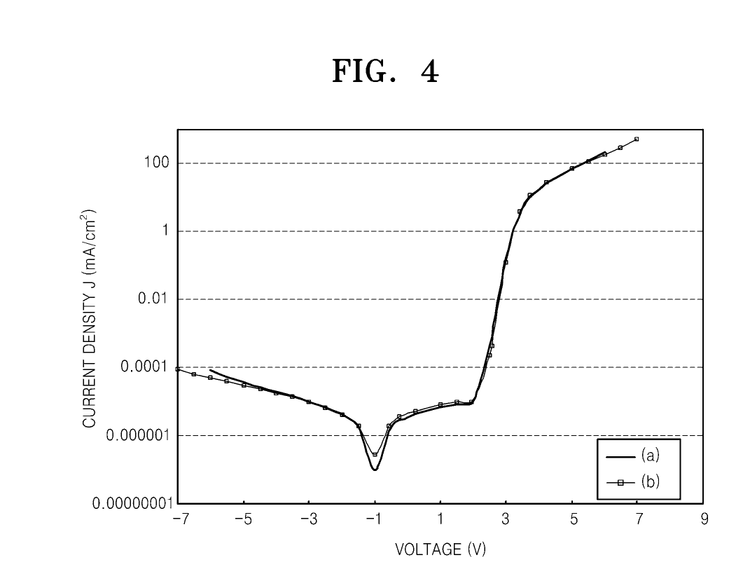

FIG. 4 is a graph showing curves of a current density J versus a voltage V with respect to two thicknesses of the first electrode 110 that includes MoOₓ and that is arranged in the OLED 100 according to the embodiment of FIG. 1. To be more specific, (a) of FIG. 4 indicates a curve obtained by measuring a current density of the OLED 100 that has the first electrode 110 including MoOₓ and having a thickness of 800 Å, and (b) of FIG. 4 indicates a curve obtained by measuring a current density of the OLED 100 that has the first electrode 110 including MoOₓ and having a thickness of 1000 Å.

In the case where ITO is used to form the first electrode of a conventional OLED according to the related art, it is required to make a thickness of the first electrode less than 100 Å. However, an electrical performance of the OLED 100 according to the embodiment of FIG. 1 is not degraded even though the first electrode 110 is formed to a thickness of 1000 Å.

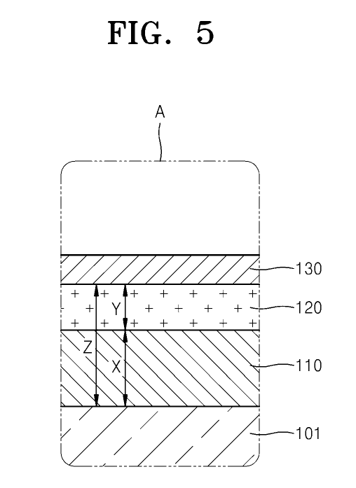

FIG. 5 is a magnified cross-sectional view of A of FIG. 1. X, Y, and Z of FIG. 5 respectively indicate a thickness of the first electrode 110, a thickness of the intermediate layer 120, and the sum total of the thicknesses X and Y. The thickness of the first electrode 110 that is a transparent electrode may be between about 20 Å and 1000 Å. In the case where the thickness of the first electrode 110 including a material selected from the group consisting of MoOₓ, WOx, YbOₓ, ReOₓ, GeOₓ, and combinations thereof is less than 20 Å, a hole injection performance of the first electrode 110 is degraded. Thus, the first electrode 110 may be formed to a thickness greater than 20 Å. In the case where the thickness of the first electrode 110 exceeds 1000 Å, transmittance with respect to light decreases and resistance increases. Thus, the thickness of the first electrode 110 may be less than 1000 Å.

The OLED 100 according to the embodiment of FIG. 1 may have a resonant structure. That is, light generated in the intermediate layer 120 may resonate between the first electrode 110 and the second electrode 130 so that an optical efficiency of the OLED 100 may be improved compared to that of conventional OLEDs.

In order to enable the light generated in the intermediate layer 120 to resonate between the first electrode 110 and the second electrode 130, the sum total Z of the thickness X of the first electrode 110 and the thickness Y of the intermediate layer 120 is important. An optical distance for resonance has a constant periodicity.

Also, a resonance distance varies according to each color. For example, in the case of a red sub-pixel, the resonance distance is approximately 1950 Å; in the case of a green sub-pixel, the resonance distance is approximately 2350 Å; and in the case of a blue sub-pixel, the resonance distance is approximately 2750 Å.

In other words, when the sum total Z is 1950 Å in the red sub-pixel, the sum total Z is 2350 Å in the green sub-pixel, and the sum total Z is 2750 Å in the blue sub-pixel, the light generated in the intermediate layer 120 resonates in each sub-pixel so that the optical efficiency is improved.

In order to obtain the above described resonance distance, the thickness of the first electrode 110 according to the embodiment of FIG. 1 may be adjusted. That is, in the case where a first electrode according to the related art is formed of ITO, it is difficult to increase a thickness of the first electrode beyond 100 Å such that a thickness of an intermediate layer is formed to be thick, or a separate layer is disposed between the first electrode and the intermediate layer or between the intermediate layer and a second electrode. However, since the intermediate layer includes organic materials, it is difficult to increase the thickness of the intermediate layer beyond a predetermined thickness. Also, in the case where the separate layer is disposed therein, an optical efficiency and an electrical performance of conventional OLEDs are degraded.

However, since the first electrode 110 according to the embodiment of FIG. 1 may be formed to a thickness of 1000 Å, the resonant structure may be easily formed without increasing a thickness of the intermediate layer 120 and/or without forming a separate layer.

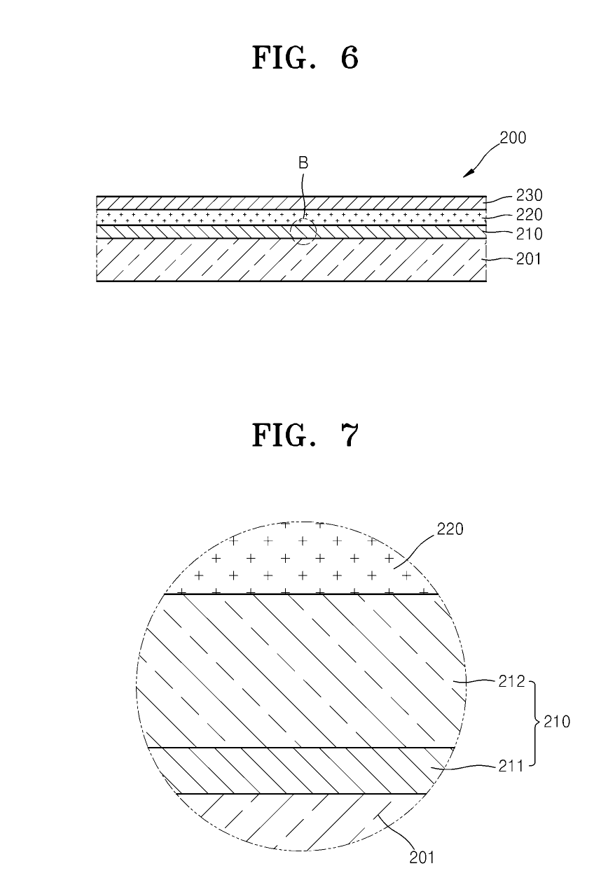

FIG. 6 is a cross-sectional view of an OLED 200 according to another embodiment of the present invention. FIG. 7 is a magnified view of B of FIG. 6. The OLED 200 according to the embodiment of FIG. 6 includes a substrate 201, a first electrode 210, an intermediate layer 220, and a second electrode 230. The OLED 200 according to the embodiment of FIG. 6 is similar to the OLED 100 according to the embodiment of FIG. 1, except for a difference with respect to the first electrode 210 of the OLED 200. Thus, for convenience of description, the OLED 200 will now be described in consideration of this difference.

The first electrode 210 is formed on the substrate 201, and includes a first layer 211 and a second layer 212. Referring to FIG. 7, the first layer 211 of the first electrode 210 is formed on the substrate 201, the second layer 212 is formed on the first layer 211, and the intermediate layer 220 is formed on the second layer 212.

The first layer 211 is formed as a reflective layer, and may include Li, Ca, LiF/Ca, LiF/Al, Al, Mg, and Ag. The second layer 212 is disposed between the first layer 211 and the intermediate layer 220, and may include a material selected from the group consisting of MoOₓ, WOx, YbOₓ, ReOₓ, GeOₓ, and combinations thereof.

The first layer 211 includes a metal having a high reflectance so as to be a reflective layer. Light, which is generated in an organic emission layer of the intermediate layer 220, is reflected from the first layer 211 and is emitted through the second electrode 230. That is, the OLED 200 has a top emission structure.

When the second layer 212 of the first electrode 210 includes the material selected from the group consisting of MoOₓ, WOx, YbOₓ, ReOₓ, GeOₓ, and combinations thereof, the material has a low optical absorption coefficient k so that the amount of light passing through the second layer 212 increases, compared to ITO. Accordingly, even if the second layer 212 is formed to a predetermined thickness, transmittance is not significantly reduced.

Also, the material selected from the group consisting of MoOₓ, WOₓ, YbOₓ, ReOₓ, GeOₓ, and combinations thereof has a faster etch rate than ITO so that it is easy to match an etch rate of the first layer 211 with an etch rate of the second layer 212, and it is easy to perform patterning with respect to the first electrode 210.

The OLED 200 according to the embodiment of FIG. 6 may have a resonant structure, and the first layer 211 is formed as the reflective layer so that a resonant effect is improved, compared to that of conventional OLEDs. The second layer 212 of the first electrode 210 may be formed to a thickness between about 20 Å and 1000 Å. In the case where the second layer 212 including the material selected from the group consisting of MoOₓ, WOx, YbOₓ, ReOₓ, GeOₓ, and combinations thereof has a thickness less than 20 Å, a hole injection performance of the first electrode 210 is degraded. Thus, the second layer 212 may be formed to a thickness greater than 20 Å. In the case where the thickness of the second layer 212 exceeds 1000 Å, transmittance with respect to light decreases and resistance increases; thus, the thickness of the second layer 212 may be less than 1000 Å.

The second electrode 230 may be formed to be a transparent electrode and may include a layer in which Li, Ca, LiF/Ca, LiF/Al, Al, Mg, or a compound of any of these is deposited toward the intermediate layer 220, and may also include thereon a layer formed of a transparent conductive material, such as ITO, IZO, ZnO, In₂O₃, or combinations thereof. The second electrode 230 may be formed of a transparent conductive material, such as ITO, IZO, ZnO, In₂O₃, or combinations thereof. Further, when formed to be the transparent electrode, the second electrode 230 may be formed of a material selected from the group consisting of MoOₓ, WOₓ, YbOₓ, ReOₓ, GeOₓ, and combinations thereof.

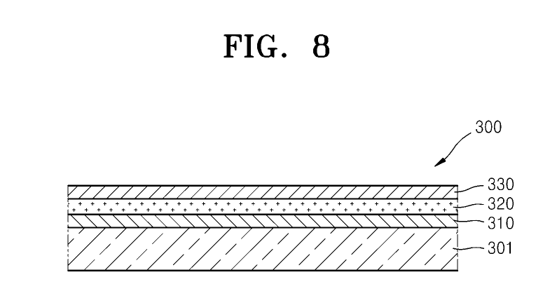

FIG. 8 is a cross-sectional view of an OLED 300 according to another embodiment of the present invention. Referring to FIG. 8, the OLED 300 according to the current embodiment includes a substrate 301, a first electrode 310, an intermediate layer 320, and a second electrode 330.

For convenience of description, the OLED 300 will now be described in consideration of a difference between the OLED 300 according to the current embodiment and the OLED 100 according to the embodiment of FIG. 1.

The first electrode 310 is formed on the substrate 301. The first electrode 310 may be formed according to a predetermined pattern by using a photolithography method or the like. The first electrode 310 may be formed to be a transparent electrode or a reflective electrode. When the first electrode 310 is formed to be the transparent electrode, the first electrode 310 may include a layer in which Li, Ca, LiF/Ca, LiF/Al, Al, Mg, or a compound of any of these is deposited toward the intermediate layer 320, and may also include thereunder a layer formed of a transparent conductive material, such as ITO, IZO, ZnO, In₂O₃, or combinations thereof. The first electrode 310 may be formed of a transparent conductive material, such as ITO, IZO, ZnO, In₂O₃, or combinations thereof. Further, when formed to be the transparent electrode, the first electrode 310 may be formed of a material selected from the group consisting of MoOₓ, WOₓ, YbOₓ, ReOₓ, GeOₓ, and combinations thereof. When the first electrode 310 is formed to be the reflective electrode, the first electrode 310 may be formed by depositing Li, Ca, LiF/Ca, LiF/Al, Al, Mg or a compound of any of these. The first electrode 310 may be a cathode electrode.

The intermediate layer 320 and the second electrode 330 are formed on the first electrode 310. The intermediate layer 320 includes an organic emission layer formed of either a low molecular weight organic material or a polymer organic material. A detailed description of the organic material forming the intermediate layer 320 is the same as that given in relation to the embodiment of FIG. 1, and thus, will be omitted here.

The second electrode 330 is formed on the intermediate layer 320. The second electrode 330 includes a material selected from the group consisting of MoOₓ, WOₓ, YbOₓ, ReOₓ, GeOₓ, and combinations thereof, and may be an anode electrode. The OLED 300 according to the current embodiment may have a resonant structure. Descriptions of other details of the OLED 300 are the same as those described in relation to the embodiment of FIG. 1, and thus, will be omitted here.

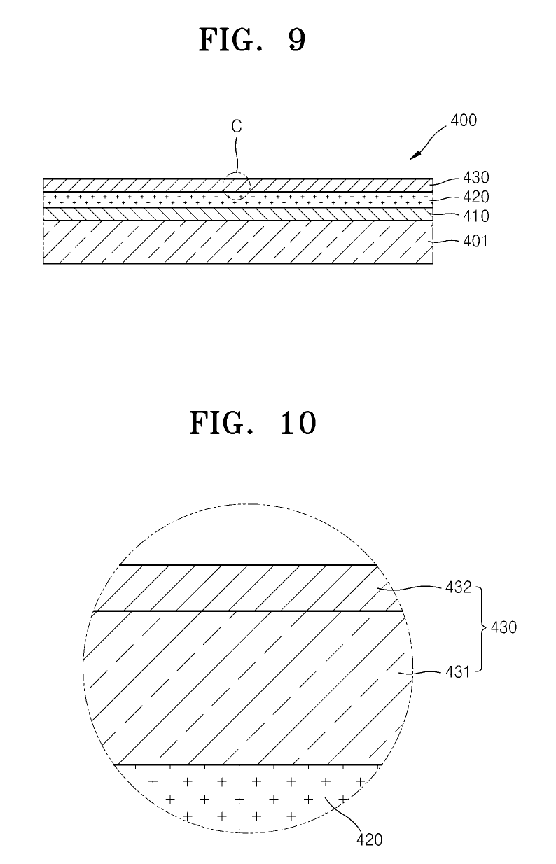

FIG. 9 is a cross-sectional view of an OLED 400 according to another embodiment of the present invention. FIG. 10 is a magnified view of C of FIG. 9. Referring to FIG. 9, the OLED 400 includes a substrate 401, a first electrode 410, an intermediate layer 420, and a second electrode 430. The OLED 400 according to the embodiment of FIG. 9 is different from the OLED 300 according to the embodiment of FIG. 8 with respect to a structure of the second electrode 430. Thus, for convenience of description, the current embodiment of FIG. 9 will now be described in consideration of this difference.

The second electrode 430 includes a first layer 431 and a second layer 432. Referring to FIG. 10, the first layer 431 is formed on the intermediate layer 420, and the second layer 432 is formed on the first layer 431.

The first layer 431 includes a material selected from the group consisting of MoOₓ, WOₓ, YbOₓ, ReOₓ, GeOₓ, and combinations thereof. The second layer 432 is formed as a reflective layer, and may include Li, Ca, LiF/Ca, LiF/Al, Al, Mg, Ag, etc. The second layer 432 includes a metal having a high reflectance so as to be a reflective layer. Light, which is generated in an organic emission layer of the intermediate layer 420, is reflected from the second layer 432 and is emitted to the first electrode 410. That is, the OLED 400 has a bottom emission structure.

The OLED 400 according to the embodiment of FIG. 9 may have a resonant structure, and the second layer 432 is formed as the reflective layer so that a resonant effect is improved, compared to conventional OLEDs. The first layer 431 of the second electrode 430 may be formed to a thickness between about 20 Å and 1000 Å. In the case where the first layer 431 including the material selected from the group consisting of MoOₓ, WOₓ, YbOₓ, ReOₓ, GeOₓ, and combinations thereof has a thickness less than 20 Å, a hole injection performance of the second electrode 430 is degraded. Thus, the first layer 431 may be formed to a thickness greater than 20 Å. In the case where the thickness of the first layer 431 exceeds 1000 Å, transmittance with respect to light decreases and resistance increases, thus, the thickness of the first layer 431 may be less than 1000 Å.

The first electrode 410 may be formed to be a transparent electrode and may include a layer in which Li, Ca, LiF/Ca, LiF/Al, Al, Mg, or a compound of any of these is deposited toward the intermediate layer 420, and may also include thereon a layer formed of a transparent conductive material, such as ITO, IZO, ZnO, In₂O₃, or combinations thereof. The first electrode 410 may be formed of a transparent conductive material, such as ITO, IZO, ZnO, In₂O₃, or combinations thereof. Further, when formed to be the transparent electrode, the first electrode 410 may be formed of a material selected from the group consisting of MoOₓ, WOₓ, YbOₓ, ReOₓ, GeOₓ, and combinations thereof.

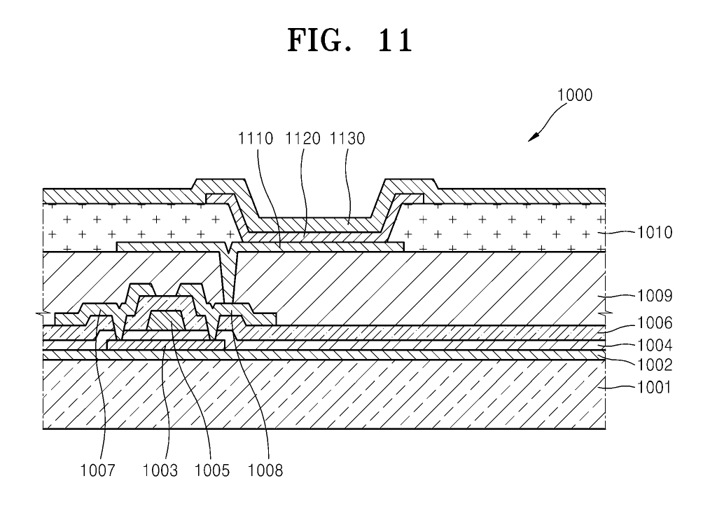

FIG. 11 is a cross-sectional view of an organic light emitting display apparatus 1000 having the OLED 100 of FIG. 1 according to an embodiment of the present invention. The organic light emitting display apparatus 1000 of FIG. 11 is an active matrix (AM) type organic light emitting display apparatus. However, the organic light emitting display apparatus 1000 is not limited thereto and thus may also be applied to a passive matrix (PM) type organic light emitting display apparatus.

Referring to FIG. 11, the organic light emitting display apparatus 1000 includes a substrate 1001, a thin film transistor (TFT), a first electrode 1110, an intermediate layer 1120, and a second electrode 1130.

Referring to FIG. 11, the TFT is formed on a top surface of the substrate 1001. Such a TFT is formed for each pixel, and is electrically connected to the first electrode 1110.

The substrate 1001 may be formed of transparent glass containing SiO₂ as a main component, but is not limited thereto and thus may also be formed of a transparent plastic material. A plastic substrate may be formed of an insulating organic material selected from the group consisting of polyethersulphone (PES), polyacrylate (PAR), polyetherimide (PEI), polyethyelene napthalate (PEN), polyethyelene terephthalate (PET), polyphenylene sulfide (PPS), polyallylate, polyimide, polycarbonate (PC), triacetate cellulose (TAC), and cellulose acetate propionate (CAP).

In a bottom emission type organic light-emitting display device in which an image is realized toward the substrate 1001, the substrate 1001 may be formed of a transparent material. However, in a top emission type organic light emitting display apparatus in which an image is realized away from the substrate 1001, the substrate 1001 need not be formed of a transparent material, and, in this case, the substrate 1001 may be formed of a metal. When the substrate 1001 is formed of the metal, the substrate 1001 may include at least one material selected from the group consisting of carbon, iron, chromium, manganese, nickel, titanium, molybdenum, stainless steel (SUS), Invar alloys, Inconel alloys, and Kovar alloys, but is not limited thereto and thus the substrate 1001 may also be formed of a metal foil.

A buffer layer 1002 may be further formed on the top surface of the substrate 1001 so as to planarize the substrate 1001 and to prevent penetration of impurities into the substrate 1001. The buffer layer 1002 may be formed of SiO₂ and/or SiNₓ. Further, the buffer layer 1002 need not be formed in all aspects.

The TFT is formed on the top surface of the substrate 1001. Such a TFT is formed for each pixel.

To be more specific, an active layer 1003 having a predetermined pattern is formed on the buffer layer 1002, if such buffer layer 1002 is present. The active layer 1003 may be formed of an inorganic semiconductor, such as amorphous silicon, monocrystalline silicon, or polycrystalline silicon, or formed of an organic semiconductor, and may include a source region, a drain region, and a channel region.

A gate insulating layer 1004, formed of SiO₂ or SiNₓ, is formed on the active layer 1003. The gate insulating layer 1004 may be formed of an inorganic material, such as a metal oxide or a metal nitride, or may be formed of an organic material, such as an insulating polymer organic material.

A gate electrode 1005 is formed on a predetermined portion, which corresponds to a portion of the active layer 1003, of a top surface of the gate insulating layer 1004. The gate electrode 1005 is connected to a gate line (not shown) that applies a TFT ON/OFF signal. The gate electrode 1005 may be formed of a metal selected from the group of Au, Ag, Cu, Ni, Pt, Pd, Al, and Mo, or may be formed of a metal alloy, such as Al—Nd alloy, Mo—W alloy, and the like but is not limited thereto.

An interlayer insulating layer 1006 is formed to cover the gate electrode 1005. A source electrode 1007 and a drain electrode 1008 are formed to contact the source region and the drain region of the active layer 1003 via contact holes, respectively, that extend through interlayer insulating layer 1006 and the gate insulating layer 1004. The source and drain electrodes 1007 and 1008 may be formed of a metal selected from the group consisting of Au, Pd, Pt, Ni, Rh, Ru, Ir and Os, or may be formed of a metal alloy containing at least two metals from the group of Al, Mo, Al—Nd alloy, Mo—W alloy, and the like but is not limited thereto.

Such a TFT is covered with a passivation layer 1009 for protection. For the passivation layer 1009, an inorganic insulating layer and/or an organic insulating layer may be used. The inorganic insulating layer may include SiO₂, SiNₓ, SiON, Al₂O₃, TiO₂, Ta₂O₅, HfO₂, ZrO₂, BaₓSr₍₁₋ₓ₎TiO₃ (BST), or lead zirconate titanate (PZT), and the organic insulating layer may include polymer derivatives having commercial polymers (poly(methyl methacrylate) (PMMA) and polystyrene (PS)) and a phenol group, an acryl-based polymer, an imide-based polymer, an allyl ether-based polymer, an amide-based polymer, a fluorine-based polymer, a p-xylene-based polymer, a vinylalcohol-based polymer, or a blend of any of these. The passivation layer 1009 may be formed as a multi-stack including the inorganic insulating layer and the organic insulating layer.

The first electrode 1110, which may be an anode electrode, is formed above the passivation layer 1009 and electrically connected to the drain electrode 1008 via a contact hole formed in the passivation layer 1009. A pixel defining layer 1010, formed of an insulating material, is formed to cover the first electrode 1110. A predetermined opening is formed on the pixel defining layer 1010, and the intermediate layer 1120 is formed in a region that is defined by the predetermined opening. After that, the second electrode 1130, which may be a cathode electrode, is formed to cover all pixels.

The first electrode 1110 may be formed according to a predetermined pattern by using a photolithography method or the like. The first electrode 1110 includes a material selected from the group consisting of MoOₓ, WOₓ, YbOₓ, ReOₓ, GeOₓ, and combinations thereof.

When the first electrode 1110 includes the material selected from the group consisting of MoOₓ, WOₓ, YbOₓ, ReOₓ, GeOₓ, and combinations thereof, the selected material has a low optical absorption coefficient k such that the amount of light passing through the first electrode 1110 increases, compared to ITO. Thus, even if the first electrode 1110 is formed to a predetermined thickness, transmittance is not significantly reduced.

Also, the material selected from the group consisting of MoOₓ, WOₓ, YbOₓ, ReOₓ, GeOₓ, and combinations thereof, has a faster etch rate than ITO and thus, it is easy to perform patterning with respect to the first electrode 1110.

The material selected from the group consisting of MoOₓ, WOₓ, YbOₓ, ReOₓ, GeOₓ, and combinations thereof has a large dipole moment and is appropriate for an electrode material. In particular, when the first electrode 1110 is formed of the selected material having a work function that is adjusted to be between 5 eV and 6.5 eV, the first electrode 1110 may be an anode electrode that has an excellent hole injection performance.

The first electrode 1110 is a transparent electrode, and may be formed to a thickness between about 20 Å and 1000 Å. In the case where the first electrode 1110 including the material selected from the group consisting of MoOₓ, WOₓ, YbOₓ, ReOₓ, GeOₓ, and combinations thereof has a thickness less than 20 Å, a hole injection performance of the first electrode 1110 is degraded. Thus, the first electrode 1110 may be formed to a thickness greater than 20 Å. In the case where the thickness of the first electrode 1110 exceeds 1000 Å, transmittance with respect to light decreases and resistance increases. Thus, the thickness of the first electrode 1110 may be less than 1000 Å.

The organic light emitting display apparatus 1000 according to the embodiment of FIG. 11 may have a resonant structure. That is, light generated in the intermediate layer 1120 may resonate between the first electrode 1110 and the second electrode 1130 so that an optical efficiency of the organic light emitting display apparatus 1000 may be improved compared to that of a conventional organic light emitting display apparatus according to the related art.

In the organic light emitting display apparatus 1000 according to the embodiment of FIG. 11, the first electrode 1110 may be formed to a thickness of 1000 Å, thus, the resonant structure may be easily formed without increasing a thickness of the intermediate layer 1120 or without forming a separate layer.

The intermediate layer 1120 and the second electrode 1130 are formed on the first electrode 1110. The intermediate layer 1120 includes an organic emission layer formed of either a low molecular weight organic material or a polymer organic material. A detailed description of the organic material forming the intermediate layer 1120 is the same as that given in relation to the embodiment of FIG. 1, and thus, will be omitted here.

The second electrode 1130 may be formed to be a transparent electrode or a reflective electrode. When formed to be the transparent electrode, the second electrode 1130 may include a layer in which Li, Ca, LiF/Ca, LiF/Al, Al, Mg, or a compound of any of these is deposited toward the intermediate layer 1220, and may also include thereon an auxiliary electrode or a bus electrode line formed of a transparent conductive material, such as ITO, IZO, ZnO, In₂O₃, or combinations thereof. The second electrode 1130 may be formed of a transparent conductive material, such as ITO, IZO, ZnO, In₂O₃, or combinations thereof. Further, when formed to be the transparent electrode, the second electrode 1130 may be formed of a material selected from the group consisting of MoOₓ, WOₓ, YbOₓ, ReOₓ, GeOₓ, and combinations thereof. When formed to be the reflective electrode, the second electrode 1130 may be formed by depositing Li, Ca, LiF/Ca, LiF/Al, Al, Mg or a compound of any of these. The second electrode 1130 may function as a cathode electrode.

Although not illustrated in FIG. 11, an encapsulation member may be disposed on the second electrode 1130. The encapsulation member (not shown) is formed to protect the first electrode 1110, the intermediate layer 1120 and the second electrode 1130 from external moisture and/or oxygen. In a top emission type organic light emitting display apparatus, the encapsulation member (not shown) is formed of a transparent material. Accordingly, the top emission type organic light emitting display apparatus may have a glass substrate structure, a plastic substrate structure, or a multi-stack structure in which an organic material and an inorganic material are stacked.

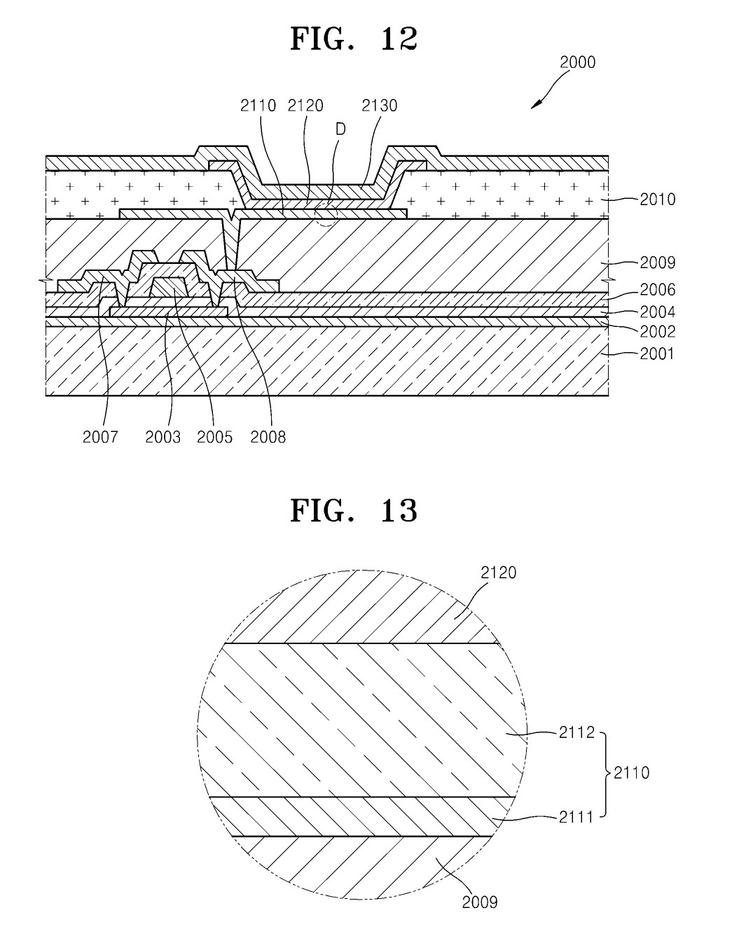

FIG. 12 is a cross-sectional view of an organic light emitting display apparatus 2000 according to another embodiment of the present invention. FIG. 13 is a magnified view of D of FIG. 12. For convenience of description, the current embodiment of FIGS. 12 and 13 will now be described in consideration of the differences with respect to the embodiment of FIG. 11. Referring to FIG. 12, the organic light emitting display apparatus 2000 includes a substrate 2001, a thin film transistor (TFT), a first electrode 2110, an intermediate layer 2120, and a second electrode 2130. Referring to FIG. 13, the first electrode 2110 includes a first layer 2111 and a second layer 2112. The first layer 2111 of the first electrode 2110 is formed on a passivation layer 2009, the second layer 2112 is formed on the first layer 2111, and an intermediate layer 2120 is formed on the second layer 2112.

The first layer 2111 may be formed as a reflective layer, and may include Li, Ca, LiF/Ca, LiF/Al, Al, Mg, or Ag. The second layer 2112 is disposed between the first layer 2111 and the intermediate layer 2120, and may include a material selected from the group consisting of MoOₓ, WOₓ, YbOₓ, ReOₓ, GeOₓ, and combinations thereof.

The first layer 2111 includes a metal having a high reflectance so as to be the reflective layer. Light, which is generated in an organic emission layer of the intermediate layer 2120, is reflected from the first layer 2111 and is emitted toward a second electrode 2130. That is, the organic light emitting display apparatus 2000 according to the current embodiment of FIG. 12 is a top emission type organic light emitting display apparatus.

When the second layer 2112 of the first electrode 2110 includes the material selected from the group consisting of MoOₓ, WOₓ, YbOₓ, ReOₓ, GeOₓ, and combinations thereof, the material has a low optical absorption coefficient k so that the amount of light passing through the second layer 2112 increases, compared to ITO. Accordingly, even if the second layer 2112 is formed up to a predetermined thickness, transmittance is not significantly reduced.

Also, the material selected from the group consisting of MoOₓ, WOₓ, YbOₓ, ReOₓ, GeOₓ, and combinations thereof has a faster etch rate than ITO so that it is easy to match an etch rate of the first layer 2111 with an etch rate of the second layer 2112, and it is easy to perform patterning with respect to the first electrode 2110.

The organic light emitting display apparatus 2000 may have a resonant structure, and the first layer 2111 is formed as the reflective layer so that a resonant effect is improved. The second layer 2112 of the first electrode 2110 may be formed to a thickness between about 20 Å and 1000 Å. In the case where the second layer 2112 including the material selected from the group consisting of MoOₓ, WOₓ, YbOₓ, ReOₓ, GeOₓ, and combinations thereof has a thickness less than 20 Å, a hole injection performance of the first electrode 2110 is degraded. Thus, the second layer 2112 may be formed to a thickness greater than 20 Å. In the case where a thickness of the second layer 2112 exceeds 1000 Å, transmittance with respect to light decreases and resistance increases, thus, the thickness of the second layer 2112 may be less than 1000 Å.

In the organic light emitting display apparatus 2000 according to the embodiment of FIG. 12, the second layer 2112 of the first electrode 2110 may be formed to a thickness of 1000 Å, and thus, the resonant structure may be easily formed without increasing a thickness of the intermediate layer 2120 and/or without forming a separate layer.

The second electrode 2130 may be formed to be a transparent electrode and may include a layer in which Li, Ca, LiF/Ca, LiF/Al, Al, Mg, or a compound of any of these is deposited toward the intermediate layer 2120, and may also include thereon a layer formed of a transparent conductive material, such as ITO, IZO, ZnO, In₂O₃, or combinations thereof. The second electrode 2130 may be formed of a transparent conductive material, such as ITO, IZO, ZnO, In₂O₃, or combinations thereof. Further, when formed to be the transparent electrode, the second electrode 2130 may be formed of a material selected from the group consisting of MoOₓ, WOₓ, YbOₓ, ReOₓ, GeOₓ, and combinations thereof.

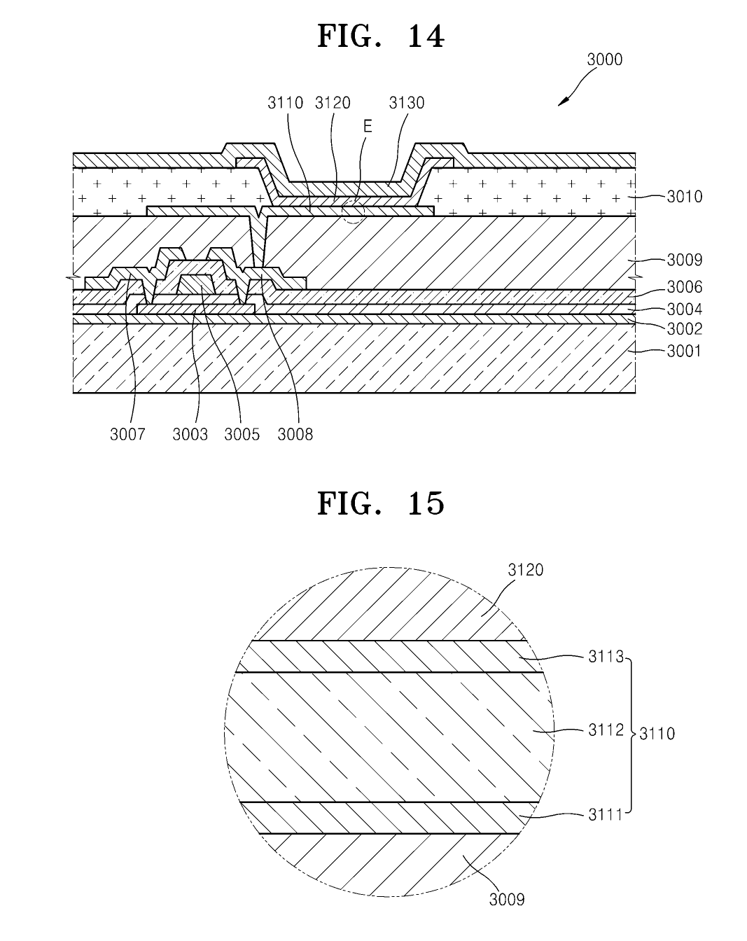

FIG. 14 is a cross-sectional view of an organic light emitting display apparatus 3000 according to another embodiment of the present invention. FIG. 15 is a magnified view of E of FIG. 14. The current embodiment of FIG. 14 is different from the embodiment of FIG. 12 with respect to a structure of a first electrode 3110. Thus, for convenience of description, the current embodiment of FIG. 14 will now be described in consideration of this difference.

The first electrode 3110 of the organic light emitting display apparatus 3000 includes a first layer 3111, a second layer 3112, and a third layer 3113. The first layer 3111 is formed on a passivation layer 3009 and includes a material selected from the group consisting of MoOₓ, WOₓ, YbOₓ, ReOₓ, GeOₓ, and combinations thereof. The second layer 3112 is formed as a reflective layer on the first layer 3111 facing toward an organic emission layer so as to reflect light generated in the organic emission layer. The third layer 3113 is disposed between the second layer 3112 and an intermediate layer 3120, and includes a material selected from the group consisting of MoOₓ, WOₓ, YbOₓ, ReOₓ, GeOₓ, and combinations thereof.

The first layer 3111 includes the material selected from the group consisting of MoOₓ, WOₓ, YbOₓ, ReOₓ, GeOₓ, and combinations thereof. Since MoOₓ, WOₓ, YbOₓ, ReOₓ, GeOₓ, and combinations thereof have excellent adherence to other members, adherence between the first electrode 3110 and the passivation layer 3009 may be enhanced.

The second electrode 3130 may be formed to be a transparent electrode and may include a layer in which Li, Ca, LiF/Ca, LiF/Al, Al, Mg, or a compound of any of these is deposited toward the intermediate layer 3120, and may also include thereon a layer formed of a transparent conductive material, such as ITO, IZO, ZnO, In₂O₃, or combinations thereof. The second electrode 3130 may be formed of a transparent conductive material, such as ITO, IZO, ZnO, In₂O₃, or combinations thereof. Further, when formed to be the transparent electrode, the second electrode 3130 may be formed of a material selected from the group consisting of MoOₓ, WOₓ, YbOₓ, ReOₓ, GeOₓ, and combinations thereof.

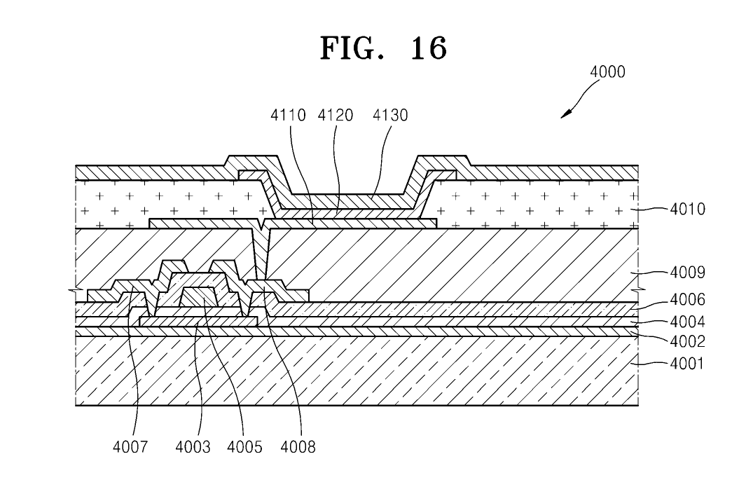

FIG. 16 is a cross-sectional view of an organic light emitting display apparatus 4000 according to another embodiment of the present invention. For convenience of description, the current embodiment of FIG. 16 will now be described in consideration of a difference with respect to the aforementioned embodiments.

Referring to FIG. 16, a first electrode 4110 is formed on a passivation layer 4009 that covers a TFT. The first electrode 4110 may be formed according to a predetermined pattern by using a photolithography method or the like, and is electrically connected to a drain electrode 4008 of the TFT.

The first electrode 4110 may be formed to be a transparent electrode or a reflective electrode. When the first electrode 4110 is formed to be the transparent electrode, the first electrode 4110 may include a layer in which Li, Ca, LiF/Ca, LiF/Al, Al, Mg, or a compound of any of these is deposited toward an intermediate layer 4120, and may also include thereunder a layer formed of a transparent conductive material, such as ITO, IZO, ZnO, In₂O₃, or combinations thereof. The first electrode 4110 may be formed of a transparent conductive material, such as ITO, IZO, ZnO, In₂O₃, or combinations thereof. Further, when formed to be the transparent electrode, the first electrode 4110 may be formed of a material selected from the group consisting of MoOₓ, WOₓ, YbOₓ, ReOₓ, GeOₓ, and combinations thereof. When the first electrode 4110 is formed to be the reflective electrode, the first electrode 4110 may be formed by depositing Li, Ca, LiF/Ca, LiF/Al, Al, Mg or a compound of any of these. The first electrode 4110 may be a cathode electrode.

The intermediate layer 4120 and a second electrode 4130 are formed on the first electrode 4110. The intermediate layer 4120 includes an organic emission layer formed of either a low molecular weight organic material or a polymer organic material. A detailed description of the organic material forming the intermediate layer 4120 is the same as that given in relation to the embodiment of FIG. 1, and thus, will be omitted here.

The second electrode 4130 is formed on the intermediate layer 4120. The second electrode 4130 includes a material selected from the group consisting of MoOₓ, WOₓ, YbOₓ, ReOₓ, GeOₓ, and combinations thereof, and may be an anode electrode.

The organic light emitting display apparatus 4000 according to the current embodiment may have a resonant structure.

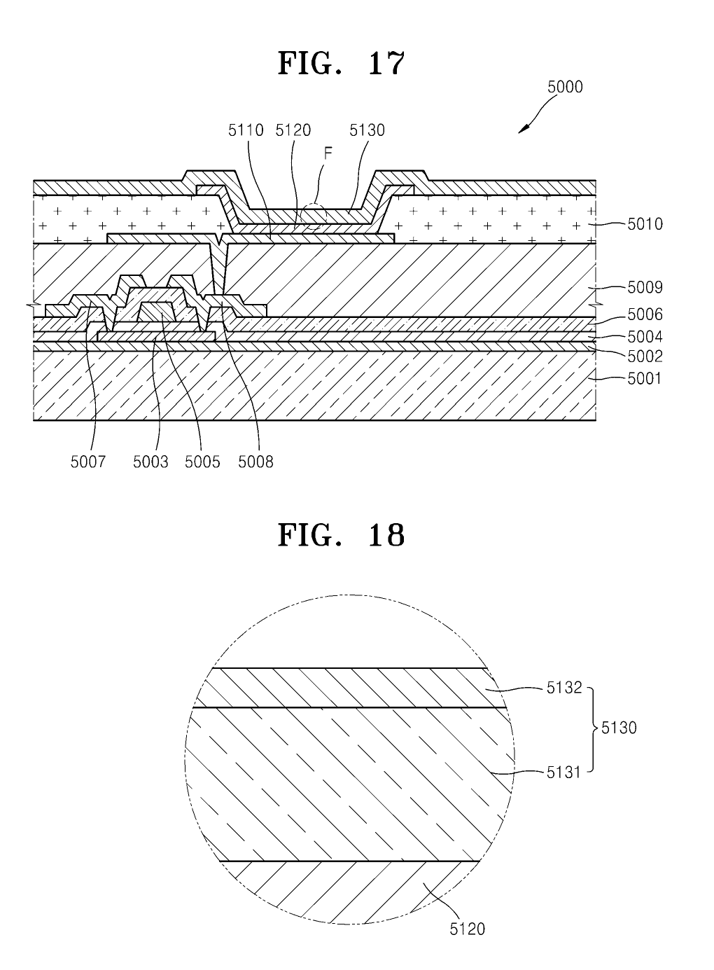

FIG. 17 is a cross-sectional view of an organic light emitting display apparatus 5000 according to another embodiment of the present invention. FIG. 18 is a magnified view of F of FIG. 17. For convenience of description, the current embodiment of FIG. 17 will now be described in consideration of a difference with respect to the aforementioned embodiments.

The organic light emitting display apparatus 5000 according to the current embodiment of FIG. 17 is the same as the organic light emitting display apparatus 4000 according to the embodiment of FIG. 16, except a structure of a second electrode 5130 in the organic light emitting display apparatus 5000. The organic light emitting display apparatus 5000 includes a substrate 5001, a thin film transistor (TFT), a first electrode 5110, an intermediate layer 5120, and the second electrode 5130. The second electrode 5130 includes a first layer 5131 and a second layer 5132. Referring to FIG. 18, the first layer 5131 is formed on an intermediate layer 5120, and the second layer 5132 is formed on the first layer 5131.

The first layer 5131 includes a material selected from the group consisting of MoOₓ, WOₓ, YbOₓ, ReOₓ, GeOₓ, and combinations thereof. The second layer 5132 is formed as a reflective layer, and may include Li, Ca, LiF/Ca, LiF/Al, Al, Mg, and Ag. The second layer 5132 includes a metal having a high reflectance so as to function as the reflective layer. Light, which is generated in an organic emission layer of the intermediate layer 5120, is reflected from the second layer 5132 and is emitted toward the first electrode 5110. That is, the organic light emitting display apparatus 5000 according to the current embodiment of FIG. 17 is a bottom emission type organic light emitting display apparatus.

The organic light emitting display apparatus 5000 according to the current embodiment of FIG. 17 may have a resonant structure, and the second layer 5132 is formed as the reflective layer so that a resonant effect is improved. The first layer 5131 of the second electrode 5130 may be formed to a thickness between about 20 Å and 1000 Å.

The first electrode 5110 may be formed to be a transparent electrode and may include a layer in which Li, Ca, LiF/Ca, LiF/Al, Al, Mg, or a compound of any of these is deposited toward the intermediate layer 5120, and may also include thereon a layer formed of a transparent conductive material, such as ITO, IZO, ZnO, In₂O₃, or combinations thereof. The first electrode 5110 may be formed of a transparent conductive material, such as ITO, IZO, ZnO, In₂O₃, or combinations thereof. Further, when formed to be the transparent electrode, the first electrode 5110 may be formed of a material selected from the group consisting of MoOₓ, WOₓ, YbOₓ, ReOₓ, GeOₓ, and combinations thereof.

Although not illustrated in FIG. 17, an encapsulation member may be disposed on the second electrode 5130. The encapsulation member (not shown) is formed to protect the first electrode 5110, the intermediate layer 5120, and the second electrode 5130 from external moisture and/or oxygen.

The organic light emitting display apparatus having the OLED according to the embodiments of the present invention includes the transparent electrode having an enhanced performance so that an optical efficiency of the organic light emitting display apparatus is improved, compared to a conventional organic light emitting display apparatus according to the related art.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An organic light emitting diode (OLED), comprising:
a first electrode formed on a substrate;
an intermediate layer formed on the first electrode and comprising an organic emission layer; and
a second electrode formed on the intermediate layer,
wherein at least one of the first electrode and the second electrode is formed as a transparent electrode comprising a material selected from the group consisting of MoOₓ, WOx, YbOₓ, ReOₓ, GeOₓ, and combinations thereof.

2. The OLED of claim 1, wherein a thickness of the transparent electrode is between about 20 Å and 1000 Å.

3. The OLED of claim 1, wherein the transparent electrode is an anode electrode.

4. The OLED of claim 1, wherein light generated in the organic emission layer resonates in the intermediate layer and the at least one of the first electrode and the second electrode formed as the transparent electrode.

5. The OLED of claim 1, wherein light generated in the organic emission layer is transmitted through the second electrode, and wherein the first electrode comprises:
a first layer formed as a reflective layer on the substrate so as to reflect the light generated in the organic emission layer; and
a second layer disposed between the first layer and the intermediate layer and comprising a material selected from the group consisting of MoOₓ, WOx, YbOₓ, ReOₓ, GeOₓ, and combinations thereof.

6. The OLED of claim 5, where in the second electrode comprises indium tin oxide, indium zinc oxide, ZnO, In₂O₃, or combinations thereof.

7. The OLED of claim 5, wherein the second electrode comprises:
a bus electrode formed on the substrate and formed of indium tin oxide, indium zinc oxide, ZnO, In₂O₃, or combinations thereof; and
a transparent layer formed of Li, Ca, LiF/Ca, LiF/Al, Al, Mg, or combinations thereof disposed between the bus electrode and the intermediate layer.

8. The OLED of claim 1, wherein light generated in the organic emission layer is transmitted through the substrate, and wherein the second electrode comprises:
a first layer formed on the intermediate layer and comprising a material selected from the group consisting of MoOₓ, WOx, YbOₓ, ReOₓ, GeOₓ, and combinations thereof; and
a second layer formed as a reflective layer on the first layer so as to reflect the light generated in the organic emission layer.

9. The OLED of claim 8, where in the first electrode comprises indium tin oxide, indium zinc oxide, ZnO, In₂O₃, or combinations thereof.

10 The OLED of claim 8, wherein the first electrode comprises:
a bus electrode formed on the substrate and formed of indium tin oxide, indium zinc oxide, ZnO, In₂O₃, or combinations thereof; and
a transparent layer formed of Li, Ca, LiF/Ca, LiF/Al, Al, Mg, or combinations thereof disposed between the bus electrode and the intermediate layer.

11. The OLED of claim 8, wherein the substrate transmits the light generated in organic emission layer.

12. The OLED of claim 1, wherein the first electrode comprises:
a first layer formed on the substrate and comprising a material selected from the group consisting of MoOₓ, WOx, YbOₓ, ReOₓ, GeOₓ, and combinations thereof;
a second layer formed as a reflective layer on the first layer to reflect the light generated in the organic emission layer; and
a third layer disposed between the second layer and the organic emission layer and comprising a material selected from the group consisting of MoOₓ, WOx, YbOₓ, ReOₓ, GeOₓ, and combinations thereof.

13. The OLED of claim 1, wherein both the first electrode and the second electrode comprise a material selected from the group consisting of MoOₓ, WOx, YbOₓ, ReOₓ, GeOₓ, and combinations thereof.

14. An organic light emitting display apparatus, comprising:
a substrate;
a thin film transistor (TFT) formed on the substrate;
a passivation layer covering the TFT and comprising a contact hole;
a first electrode formed on the passivation layer and electrically connected to the TFT via the contact hole;
an organic emission layer formed on the first electrode; and
a second electrode formed on the organic emission layer,
wherein at least one of the first electrode and the second electrode is formed as a transparent electrode comprising a material selected from the group consisting of MoOₓ, WOx, YbOₓ, ReOₓ, GeOₓ, and combinations thereof.

15. The organic light emitting display apparatus of claim 14, wherein a thickness of the transparent electrode is between about 20 Å and 1000 Å.

16. The organic light emitting display apparatus of claim 14, wherein the transparent electrode is an anode electrode.

17. The organic light emitting display apparatus of claim 14, wherein the light generated in the organic emission layer resonates in the intermediate layer and the at least one of the first electrode and the second electrode.

18. The organic light emitting display apparatus of claim 14, wherein light generated in the organic emission layer is transmitted through the second electrode, and wherein the first electrode comprises:
a first layer formed as a reflective layer on the passivation layer so as to reflect the light generated in the organic emission layer; and
a second layer disposed between the first layer and the organic emission layer and comprising a material selected from the group consisting of MoOₓ, WOx, YbOₓ, ReOₓ, GeOₓ, and combinations thereof.

19. The organic light emitting display apparatus of claim 14, wherein light generated in the organic emission layer is transmitted through the substrate, and wherein the second electrode comprises:
a first layer formed on the organic emission layer and comprising a material selected from the group consisting of MoOₓ, WOx, YbOₓ, ReOₓ, GeOₓ, and combinations thereof; and
a second layer formed as a reflective layer on the first layer so as to reflect the light generated in the organic emission layer.

20. The organic light emitting display apparatus of claim 14, wherein the first electrode comprises:
a first layer formed on the passivation layer and comprising a material selected from the group consisting of MoOₓ, WOx, YbOₓ, ReOₓ, GeOₓ, and combinations thereof;
a second layer formed as a reflective layer on the first layer facing the organic emission layer so as to reflect the light generated in the organic emission layer; and
a third layer disposed between the second layer and the organic emission layer and comprising a material selected from the group consisting of MoOₓ, WOx, YbOₓ, ReOₓ, GeOₓ, and combinations thereof.

21. The organic light emitting display apparatus of claim 14, wherein the substrate comprises glass, plastic, or a multi-stack structure in which an organic material and inorganic material are stacked.
